(19) United States
(12) Patent Application Publication
(10) Pub. No.: US 2017/0057129 A1
(43) Pub. Date: Mar. 2, 2017

(54) ROLL OVER CAN DRIVE APPARATUS OF TIRE BUILDING MACHINE

(71) Applicant: HANKOOK TIRE CO., LTD., Seoul (KR)

(72) Inventor: Jung Woo SON, Daejeon (KR)

(21) Appl. No.: 15/246,473

(22) Filed: Aug. 24, 2016

(30) Foreign Application Priority Data
Aug. 24, 2015 (KR) 10-2015-0118575

(51) Int. Cl. B29C 43/46; B29D 30/10

(52) U.S. Cl. CPC B29C 43/46; B29D 30/10

(57) ABSTRACT

The present invention relates to a roll over can drive apparatus of tire building machine supporting a bladder turning up a green tire semi-finished product on the molding drum when the bladders are expanded in the green tire molding process, and more specifically, to a roll over can of the tire building machine in which an operation cycle time and failure rate are reduced from a simplified structure. For this, the present invention discloses a roll over can drive device of a tire molding machine comprising: a bladder which supplies air to an interior of a various semi-finished products located on a forming drum and turns up the semi-finished products which located on a bead outside, and a roll over can which pushes the bladder to build a green tire, wherein the roll over can rotates on an axis of rotation of a supporting frame by a cylinder, and wherein the cylinder being connected to a support of the roll over can is mounted via a hinge axis to a top of the support frame.

### BACKGROUND OF THE INVENTION

1. Field of the Invention

The present invention relates to a roll over can drive apparatus of tire building machine supporting a bladder turning up a green tire semi-finished product on the molding drum when the bladders are expanded in the green tire molding process, and more specifically, to a roll over can of the tire building machine in which an operation cycle time and failure rate are reduced from a simplified structure.

2. Description of the Related Art

In the tire building process, all tire semi-finished products constituting the tire are arranged or placed on the building drum in the order. When the green tire is built as the tire building process like this, all kind of tire semi-finished products arranged on the building drum are pressed using a turn up bladder in order to make the green tire.

For example, as shown in FIG. 3, an air is supplied on an interior of the semi-finished product 102 such as a side wall, a carcass, etc. arranged on the building drum 101 in a direction of arrow A. In an outer of a bead portion 103, a bladder 104 is expanded by an air supplied from a direction of arrow B. If a roll over can 105 which actuates into a direction of arrow C presses the bladder 104, the bladder 104 turns up the semi-finished product in order to build a tire.

As the conventional actuation of the roll over can 105 actuating as stated above is shown in FIG. 4, when the roll over can 105 comes close to the bladder 104 and pushes the bladder, the roll over can 105 is moved along a X-axis linear guide 107 and a Y-axis liner guide 108 by a driving power of a motor.

At this time, if the roll over can 10 turns up the direction of X-axis, a great load on the Y-axis linear guide 108a will occur, therefore, the Y-axis linear guide 107 will be damaged and experience the failure.

Also, since the roll over can 105 of the conventional roll over can drive apparatus is alternatively moving forward and backward the direction of the X-axis and Y-axis, the actuating cycle time will be longer. Accordingly, there is a problem with a decrease in productivity, and there is also disadvantage in a layout of equipment taking up the large space.

3. Prior Art Documents

Korean Patent No. 101121010 (Jan. 20, 2011)

### SUMMARY OF THE INVENTION

Thus, as the present invention invented to solve the above-mentioned conventional problem, the object of the present invention is to provide the roll over can of the building tire which the operation load of the roll over can for turning up the bladder, the operation cycle time, and the layout space of equipment is decreased during the green tire building process.

In order to achieve the above-mentioned purpose, the present invention discloses a roll over can drive device of a tire molding machine comprising: a bladder which supplies air to an interior of a various semi-finished products located on a forming drum and turns up the semi-finished products which located on a bead outside, and a roll over can which pushes the bladder to build a green tire, wherein the roll over can rotates on an axis of rotation of a supporting frame by a cylinder, and wherein the cylinder being connected to a support of the rolls over can is mounted via a hinge axis to a top of the support frame.

### BRIEF DESCRIPTION OF THE DRAWINGS

The above and other aspects, features and advantages of the invention will become apparent from the following detailed description in conjunction with the accompanying drawings, in which:

FIG. 1 is a front view of a roll over can drive device of a tire molding machine installed according to the present invention.

FIG. 2 is a side view of FIG. 1, showing the operating conditions of the tire molding machine.

FIG. 3 is a cross-sectional view of the schematically operating conditions showing processes which builds the green tire in the conventional tire molding machine.

FIG. 4 is a plain view showing the operating conditions of the roll over can drive device of the conventional tire molding machine.

### DETAILED DESCRIPTION OF THE EMBODIMENTS

Hereinafter, referring to the attached drawings, the preferred embodiment of the present invention is particularly illustrated, those skilled in the art will appreciate that the presently disclosed embodiments teach by way of example and not by limitation. Therefore, the matter contained in the above description or shown in the accompanying drawings should be interpreted as illustrative and not in a limiting sense.

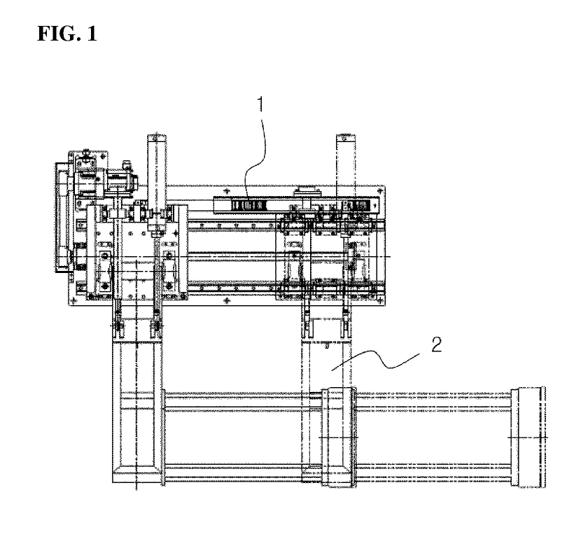

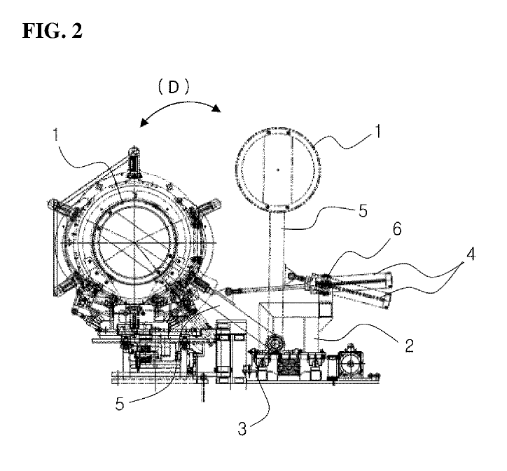

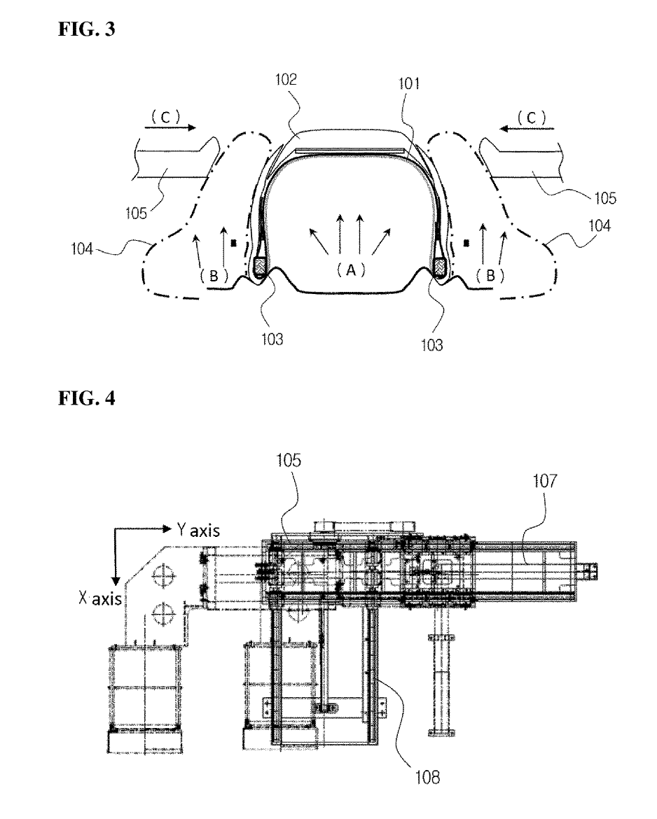

FIGS. 1 and 2 are the front and side views of the roll over can drive device of the tire molding machine installed according to the present invention.

The present invention discloses a roll over can drive device of a tire molding machine comprising: a bladder which supplies air to an interior of a various semi-finished products 102 located on a forming drum 101 and turns up the semi-finished products which located on a bead 103 outside, and a roll over can 1 which pushes the bladder to build a green tire, wherein the roll over can 1 rotates on an axis 3 of rotation of a supporting frame 2 by a cylinder 4, and wherein the cylinder 4 being connected to a support 5 of the rolls over can 1 is mounted via a hinge axis 6 to a top of the support frame 2.

That is to say, as shown in FIG. 2, as the roll over can 1 rotates on the central axis 3 of rotation of a supporting frame 2 along the arrow D in a clockwise and counterclockwise direction, the roll over can 1 will push the bladder 104 and turn up to come into contact with the bladder, and vise versa the bladder 104 will be separate from the contact with the roll over can 1. Therefore, the approach and separation between the roll over can 1 and the bladder 104 will occur.

A swing or rotation of the roll over can 1 like this can reduce the operation load more than the conventional equipment having the driving mechanism of the X-axis and Y-axis linear movement.

Furthermore, if the cylinder 4 by the swing of the roll over can 1 pushes the support 5 of the roll over can 1, the support 5 of the roll over can 1 will rotate on the axis 3 of rotation of the supporting frame 2, and then the cylinder 4 will be tilted around the hinge axis 6 at the top of the supporting frame 2. Therefore, the swing of pushing or pulling the support 5 of the roll over can 1 will occur.

As described the above, the roll over can drive apparatus of the tire building machine according to the present invention changes the actuation structure of the roll over can operation from the conventional X-axis and Y-axis linear movement to the swing or rotation type of the roll over can, and the operation load of the roll over can for turning up the bladder is reduced more than the conventional X-axis and Y-axis linear movement, therefore, the equipment failure rate will be decreased from the simplified structure, the reduction of the operation cycle time will increase the productivity, and the layout space of equipment will be reduced during the green tire building process.

In the roll over can drive device of the tire molding machine according to the present invention, when the roll over can drive device approaches to the bladder and the roll over can drive device separates from the bladder, the roll over can drive device swing at the frame by the cylinder. Therefore, the present invention has effect in compared with the conventional X-axis and Y-axis linear movement that the operation load of the roll over can for turning up the bladder and the equipment failure rate will be decreased from the simplified structure, and also the operation cycle time and the layout space of equipment will be reduced during the green tire building process.

1. A roll over can drive device of a tire molding machine comprising: a bladder which supplies air to an interior of a various semi-finished products located on a forming drum and turns up the semi-finished products which located on a bead outside, and a roll over can which pushes the bladder to build a green tire,
wherein the roll over can rotates on an axis of rotation of a supporting frame by a cylinder, and wherein the cylinder being connected to a support of the roll over can is mounted via a hinge axis to a top of the support frame.

2. The roll over can drive device of a tire molding machine as claimed in claim 1, wherein the cylinder is tilted around the hinge axis of the supporting frame.
